(19) United States
(12) Patent Application Publication
(10) Pub. No.: US 2007/0116930 A1
(43) Pub. Date: May 24, 2007

(54) Surface reforming method and surface reforming apparatus of thermoplastic resin, and molded product

(75) Inventors: Atsushi Yamada, Ibaraki (JP); Atsushi Yusa, Ibaraki (JP)

Correspondence Address: BLANK ROME LLP, 600 NEW HAMPSHIRE AVENUE, N.W., WASHINGTON, DC, 20037, US

(73) Assignees: SEIKOH GIKEN Co., Ltd., Matsudo-shi (JP); HITACHI MAXELL, Ltd., Osaka (JP)

(21) Appl. No.: 11/602,177

(22) Filed: Nov. 21, 2006

(30) Foreign Application Priority Data
Nov. 22, 2005 (JP) 2005-337343

(51) Int. Cl. B27N 3/08; B32B 3/00

(52) U.S. Cl. 428/156; 264/83; 428/457

(57) ABSTRACT

To cause uniform infiltration in a thermoplastic resin surface in a short time using a small amount of a surface reforming material. A surface reforming method of a thermoplastic resin includes a step of opening a movable mold after a thermoplastic resin is molded in a cavity to form a gap between a portion of a molded product and a stationary mold, a step of introducing supercritical fluid, subcritical fluid, or high pressure gas including a surface reforming material into the gap, a step of narrowing the gap by closing the movable mold by a predetermined amount to prevent leaking of the introduced supercritical fluid, subcritical fluid, or high pressure gas from the gap, and of charging the supercritical fluid, the subcritical fluid, or the high pressure gas into a narrowed second gap, and a step of clamping and compressing the molded product.

### CROSS-REFERENCE TO RELATED APPLICATIONS

This application is based upon and claims the benefit of priority from the prior Japanese Patent Application No. 2005-337343, filed on Nov. 22, 2005; the entire contents of which are incorporated herein by reference.

### BACKGROUND OF THE INVENTION

1. Field of the Invention

The present invention relates to a surface reforming method of a thermoplastic resin, a surface reforming apparatus of the thermoplastic resin and a molded product, using supercritical fluid such as supercritical carbon dioxide or high pressure gas such as high pressure carbon dioxide as a medium of a surface reforming material.

2. Description of the Related Art

In recent years, techniques for utilizing supercritical fluid or high pressure gas as medium are researched. The supercritical fluid has the same level of diffusibility as gas and the same level density as liquid, and there are dissolved substances which are dissolved in a medium which is in a subcritical state or a normal high pressure gas state. Therefore, a surface reforming process in which these properties are applied for reforming a surface of a polymer such as thermoplastic resin has been developed.

For example, a technique disclosed in Japanese Patent Application Laid-open (JP-A) No. 2005-205898 is a related art of the above development.

While the molding method described in JP-A No. 2005-205898 is an invention made by the present inventors, as a result of their research, it has been found that it takes some time for the reforming process, and it is necessary to perform a heat cycle molding which cools a mold for suppressing foaming. Thus, it is necessary to increase the cycle time.

### SUMMARY OF THE INVENTION

The present invention has been achieved to solve the above problem. It is an object of the present invention to provide a surface reforming method of a thermoplastic resin, a surface reforming apparatus of the thermoplastic resin and a molded product capable of causing uniform infiltration in the thermoplastic resin surface in a short time using a small amount of a surface reforming material.

To achieve the above object, according to one aspect of the present invention, there is provided a surface reforming method of a thermoplastic resin comprising:
a gap forming step of opening a movable mold after a thermoplastic resin is molded in a mold cavity to form a gap between a portion of a molded product and a stationary mold;
an introducing step of introducing supercritical fluid, subcritical fluid, or high pressure gas including a surface reforming material into the gap;
a charging step of narrowing the gap by closing the movable mold by a predetermined amount to prevent leaking of the introduced supercritical fluid, subcritical fluid, or high pressure gas from the gap, and of charging the supercritical fluid, the subcritical fluid, or the high pressure gas into a narrowed second gap; and
a compressing step of clamping and compressing the molded product.

According to another aspect of the present invention, there is provided the surface reforming method of a thermoplastic resin, wherein at least the charging step and the compressing step are performed by controlling a mold clamping force of the movable mold.

According to a still another aspect of the present invention, there is provided a molded product obtained by a following surface reforming method of a thermoplastic resin, in which a surface reforming material which is infiltrated into a portion of the molded product is metal fine grain, the method comprising:
a gap forming step of opening a movable mold after a thermoplastic resin is molded in a mold cavity to form a gap between a portion of the molded product and a stationary mold;
an introducing step of introducing supercritical fluid, subcritical fluid, or high pressure gas including the surface reforming material into the gap;
a charging step of narrowing the gap by closing the movable mold by a predetermined amount to prevent leaking of the introduced supercritical fluid, subcritical fluid, or high pressure gas from the gap, and of charging the supercritical fluid, the subcritical fluid, or the high pressure gas into a narrowed second gap; and
a compressing step of clamping and compressing the molded product.

According to a still another aspect of the present invention, there is provided an injection molded product obtained by a following surface reforming method of a thermoplastic resin, in which a periphery of a portion of the injection molded product into which a surface reforming material infiltrates is surrounded by a projection or a recess, the method comprising:
a gap forming step of opening a movable mold after a thermoplastic resin is molded in a mold cavity to form a gap between a portion of the molded product and a stationary mold;
an introducing step of introducing supercritical fluid, subcritical fluid, or high pressure gas including a surface reforming material into the gap;
a charging step of narrowing the gap by closing the movable mold by a predetermined amount to prevent leaking of the introduced supercritical fluid, subcritical fluid, or high pressure gas from the gap, and of charging the supercritical fluid, the subcritical fluid, or the high pressure gas into a narrowed second gap; and
a compressing step of clamping and compressing the molded product.

According to a still another aspect of the present invention, there is provided a surface reforming method of a thermoplastic resin comprising:
a gap forming step of opening a movable mold after a thermoplastic resin is molded in a mold cavity to form a gap between a portion of a molded product and a stationary mold;
an introducing step of introducing supercritical fluid, subcritical fluid, or high pressure gas including a surface reforming material into the gap;
a charging step of narrowing the gap by closing the movable mold by a predetermined amount to prevent leaking of the introduced supercritical fluid, subcritical fluid, or high pressure gas from the gap, and of charging the supercritical fluid, the subcritical fluid, or the high pressure gas into a narrowed second gap;
a maintaining step of further closing the movable mold to maintain a state where the second gap is narrowed to a third gap for promoting infiltration of the surface reforming material included in the charged supercritical fluid, the subcritical fluid, or the high pressure gas into the portion; and
a compressing step of clamping and compressing the molded product.

According to a still another aspect of the present invention, there is provided the surface reforming method of a thermoplastic resin, wherein at the introducing step, the gap formed by the gap forming step is widened by a pressure of the introduced supercritical fluid, subcritical fluid, or high pressure gas, and the movable mold is maintained in a state where the widened first gap is maintained.

According to a still another aspect of the present invention, there is provided the surface reforming method of a thermoplastic resin, wherein the charging step is realized in such a manner that when a projection and a recess which are respectively formed on a periphery of the portion of a molded product and on a portion of the stationary mold corresponding to the periphery and which are opposed to each other approach the second gap, the supercritical fluid, the subcritical fluid, or the high pressure gas is prevented from leaking.

According to a still another aspect of the present invention, there is provided the surface reforming method of a thermoplastic resin, wherein at the maintaining step, the supercritical fluid, the subcritical fluid, or the high pressure gas including the charged surface reforming material infiltrates into the portion of the molded product, the movable mold is gradually closed, and the maintaining step is continued until the gradual closing motion stops.

According to a still another aspect of the present invention, there is provided the surface reforming method of a thermoplastic resin, wherein at the compressing step, the movable mold which forms a cavity for defining a product shape between the movable mold and the stationary mold is moved forward, thereby compressing the molded product.

According to a still another aspect of the present invention, there is provided the surface reforming method of a thermoplastic resin, wherein at the compressing step, a mold part surrounding the mold cavity surrounds the molded product, moves the movable mold forward, and compresses the molded product.

According to a still another aspect of the present invention, there is provided the surface reforming method of a thermoplastic resin, wherein at least the charging step, the maintaining step, and the compressing step are performed by controlling a mold clamping force of the movable mold.

According to a still another aspect of the present invention, there is provided the surface reforming method of a thermoplastic resin, wherein the gap forming step is performed by controlling a position of the movable mold.

According to a still another aspect of the present invention, there is provided the surface reforming method of a thermoplastic resin, wherein at the introducing step, the gap formed at the gap forming step is widened to the first gap by a pressure of the supercritical fluid, the subcritical fluid, or the high pressure gas and then, position control of the movable mold is switched to mold clamping force control.

According to a still another aspect of the present invention, there is provided a molded product obtained by a following surface reforming method of a thermoplastic resin, in which a surface reforming material which is infiltrated into a portion of the molded product is metal fine grain, the method comprising:
a gap forming step of opening a movable mold after a thermoplastic resin is molded in a mold cavity to form a gap between a portion of the molded product and a stationary mold;
an introducing step of introducing supercritical fluid, subcritical fluid, or high pressure gas including the surface reforming material into the gap;
a charging step of narrowing the gap by closing the movable mold by a predetermined amount to prevent leaking of the introduced supercritical fluid, subcritical fluid, or high pressure gas from the gap, and of charging the supercritical fluid, the subcritical fluid, or the high pressure gas into a narrowed second gap;
a maintaining step of further closing the movable mold to maintain a state where the second gap is narrowed to a third gap for promoting infiltration of the surface reforming material included in the charged supercritical fluid, the subcritical fluid, or the high pressure gas into the portion; and
a compressing step of clamping and compressing the molded product.

According to a still another aspect of the present invention, there is provided the molded product, wherein the portion of the molded product into which the surface reforming material infiltrated is formed with a metal film by plating.

According to a still another aspect of the present invention, there is provided an injection molded product obtained by a following surface reforming method of a thermoplastic resin, in which a periphery of a portion of the injection molded product into which a surface reforming material infiltrates is surrounded by a projection or a recess, the method comprising:
a gap forming step of opening a movable mold after a thermoplastic resin is molded in a mold cavity to form a gap between a portion of the molded product and a stationary mold;
an introducing step of introducing supercritical fluid, subcritical fluid, or high pressure gas including a surface reforming material into the gap;
a charging step of narrowing the gap by closing the movable mold by a predetermined amount to prevent leaking of the introduced supercritical fluid, subcritical fluid, or high pressure gas from the gap, and of charging the supercritical fluid, the subcritical fluid, or the high pressure gas into a narrowed second gap;
a maintaining step of further closing the movable mold to maintain a state where the second gap is narrowed to a third gap for promoting infiltration of the surface reforming material included in the charged supercritical fluid, the subcritical fluid, or the high pressure gas into the portion; and
a compressing step of clamping and compressing the molded product.

According to a still another aspect of the present invention, there is provided the injection molded product, wherein the surface reforming material is metal fine grain.

According to a still another aspect of the present invention, there is provided the injection molded product, wherein height or depth of the projection or the recess is 0.01 mm or more and 0.5 mm or less.

According to a still another aspect of the present invention, there is provided a surface reforming apparatus of a thermoplastic resin, comprising:
a stationary mold;
a movable mold; and
an introducing/discharging unit of supercritical fluid, subcritical fluid, or high pressure gas including a surface reforming material; wherein
a projection or a recess are formed on a periphery of a portion of a molded product which is separated from the stationary mold when the movable mold is opened after the thermoplastic resin is molded in a mold cavity and a portion of the stationary mold corresponding to the periphery, and the projection and the recess are formed to be opposed to each other.

According to a still another aspect of the present invention, there is provided the surface reforming apparatus of the thermoplastic resin, wherein the projection or the recess functions to prevent leaking of the supercritical fluid, the subcritical fluid, or the high pressure gas, which is introduced from the introducing/discharging unit by opening the movable mold after the molding, and then charged between the stationary mold and the portion of the molded product by closing the movable mold by a predetermined amount.

### BRIEF DESCRIPTION OF THE ACCOMPANYING DRAWINGS

These and other objects and the configuration of the present invention will become clearer from the following description of the preferred embodiments, read in connection with the accompanying drawings in which:

FIG. 1 is a schematic sectional view of a surface reforming apparatus (forming step) of a thermoplastic resin according to the present invention;

FIG. 2 is a schematic sectional view of a surface reforming apparatus (gap forming step) of a thermoplastic resin according to the present invention;

FIG. 3 is a schematic sectional view of a surface reforming apparatus (introducing step) of a thermoplastic resin according to the present invention;

FIG. 4 is a schematic sectional view of a surface reforming apparatus (charging step) of a thermoplastic resin according to the present invention;

FIG. 5 is a schematic sectional view of a surface reforming apparatus (maintaining step) of a thermoplastic resin according to the present invention;

FIG. 6 is a schematic sectional view of a surface reforming apparatus (compressing step) of a thermoplastic resin according to the present invention; and

FIG. 7 is a schematic sectional view of a surface reforming apparatus (gas discharging step) of a thermoplastic resin according to the present invention.

### DETAILED DESCRIPTION OF THE INVENTION

Embodiments of the present invention will be explained with reference to the accompanying drawings.

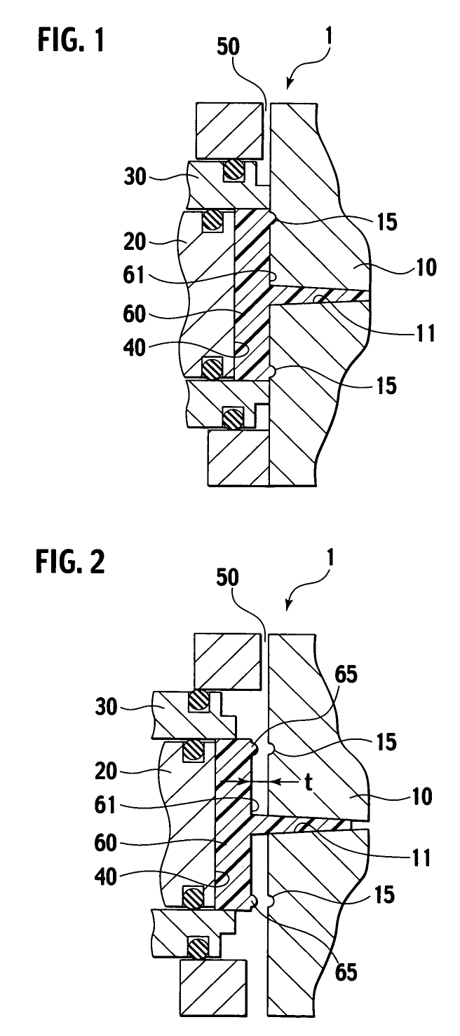

All of the drawings are schematic sectional views of a surface reforming apparatus of a thermoplastic resin according to the present invention, and FIGS. 1 to 7 show steps of a surface reforming method of the thermoplastic resin of the invention.

The surface reforming apparatus 1 of the thermoplastic resin utilizes an injection molding machine (not shown). In the surface reforming apparatus 1 of thermoplastic resin, a cavity 40 of a mold which is a space into which resin is charged can be opened and closed by a stationary mold 10 mounted on a fixed platen of an injection molding machine, a movable mold 20 mounted on a movable platen, and a cavity ring (mold part) 30 surrounding an outer periphery of the cavity.

A pellet of thermoplastic resin supplied to a plasticizing cylinder from a hopper (not shown) of the injection molding machine is abruptly plasticized and melted by rotation of a screw in the plasticizing cylinder, and then charged into the cavity 40 through a sprue 11 of the stationary mold 10 from the nozzle tip end.

The thermoplastic resin surface reforming apparatus 1 includes an introducing/discharging unit 50 of supercritical fluid, subcritical fluid, or high pressure gas including a surface reforming material. The introducing/discharging unit 50 is located outside of a periphery of the cavity 40.

The surface reforming material is metal fine grain. The metal fine grain means metal complex, metal alkoxide, or its derivatized material which is dissolved in supercritical fluid or the like.

Mutually opposed projection 65 and recess 15 are formed in a periphery of a surface-reformed portion 61 of a molded product 60 which is separated from the stationary mold 10 when the movable mold 20 is opened after the thermoplastic resin is molded in the cavity 40 and a portion of the stationary mold 10 corresponding to the periphery.

The projection 65 is continuously formed such as to surround a periphery of the surface-reformed portion 61. The recess 15 is a continuous groove which is opposed to the projection 65.

These projection (projecting streak) 65 and the recess (groove) 15 function to prevent leaking of the supercritical fluid, the subcritical fluid, or the high pressure gas, which is introduced from the introducing/discharging unit 50 by opening the movable mold 20 after the molded product 60 is molded, and then charged between the stationary mold 10 and the surface-reformed portion 61 of the molded product 60 by closing the movable mold 20 by a predetermined amount.

The projection (projecting streak) 65 and the recess (groove) 15 can have a reversed relation. That is, a recess (groove) 65 can be formed around the surface-reformed portion 61 of the molded product 60. A projection (projecting streak) 15 can be formed at a corresponding portion of the stationary mold 10. A step can be formed instead of the projection and the recess.

It is preferable that height/depth of the projecting streak/groove 65, groove/projecting streak 15 is 0.01 mm or more and 0.5 mm or less. If the height/depth is less that 0.01 mm, the concentration of the reforming material is lowered, and sufficient reforming effect can not be obtained. If the height/depth is more than 0.5 mm, the amount of gas such as supercritical fluid sealed by the projecting streak/groove 65, groove/projecting streak 15 is increased, and non-melted the supercritical carbon dioxide remains and foaming occurs.

### EXAMPLE

As one example of the molded product 60, polycarbonate is used as the thermoplastic resin, a disk shape which is provided at its center with a sprue and which has diameter of 65 mm and thickness of 0.8 mm was selected.

The projection 65 and the recess 15 are projecting streak/groove having a line width of 0.1 mm, height/depth of 0.1 mm, and semi-circular area of cross section.

When the molded product 60 having the disk shape is injection molded and the surface reforming processing is performed at the same time. Therefore, in the surface reforming apparatus 1 of thermoplastic resin, various portions are controlled in temperature. The temperature of the plasticizing cylinder is controlled to 325° C. The stationary mold 10 and the movable mold 20 are controlled in temperature by cooling water of 125° C. which flows through a temperature adjusting circuit (not shown).

The surface reforming apparatus 1 of thermoplastic resin has such a mold structure that if the mold opening amount is 2 mm or less, high pressure gas of 25 MPa or less can be sealed.

Next, a surface reforming method of thermoplastic resin using the surface reforming apparatus 1 of the thermoplastic resin will be explained step by step with reference to FIGS. 1 to 7.

First, as shown in FIG. 1, thermoplastic resin (polycarbonate) which was abruptly plasticized and melted in a plasticizing cylinder (not shown) of the injection molding machine is charged into the cavity 40 through the sprue 11 of the stationary mold 10 from the nozzle tip end, and the thermoplastic resin is molded (forming step).

Next, as shown in FIG. 2, the movable mold 20 is opened, and a gap t is formed between the stationary mold 10 and the surface-reformed portion 61 of the molded product 60 (gap forming step). At this time, the cavity ring 30 is also retreated.

Specifically, the position of the movable mold 20 is controlled by an electric mold clamping mechanism (not shown), the cavity 40 is opened by 0.1 mm, and the gap t is formed.

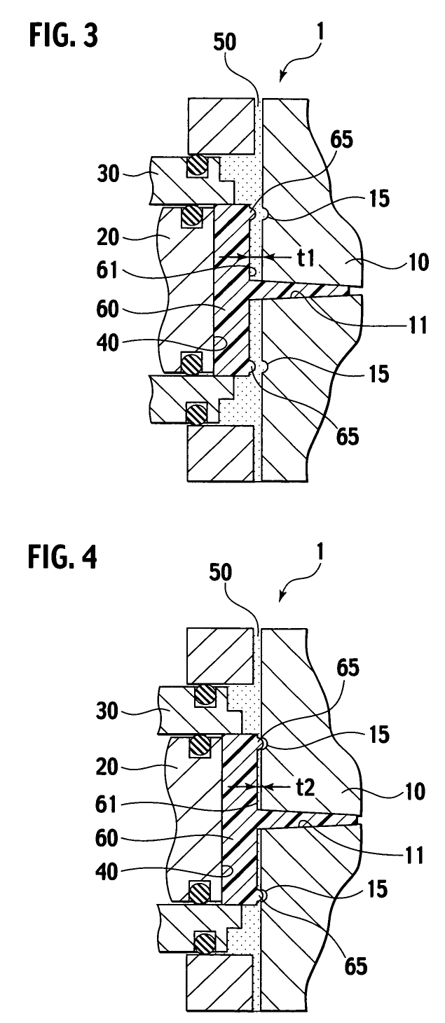

Next, as shown in FIG. 3, supercritical fluid, subcritical fluid, or high pressure gas including a surface reforming material is introduced into the gap t from the introducing/discharging unit 50 (introducing step).

At this time, the gap t formed by the gap forming step is widened by the pressure of the introduced supercritical fluid, the subcritical fluid, or the high pressure gas. The movable mold 20 is maintained in a state where the widened first gap t1 is maintained.

More specifically, supercritical carbon dioxide in which acetylacetonate hexafluorosilicate which is metal complex as the surface reforming material was melted was introduced into the gap t. At this time, the movable mold 20 is opened by the gas pressure of the supercritical carbon dioxide until the gap t becomes t1 (t<t1). The position control of the movable mold 20 was switched to mold clamping force control, and the first gap t1 was maintained.

Next, as shown in FIG. 4, in order to prevent the introduced supercritical fluid, subcritical fluid, or high pressure gas from leaking from the first gap t1, the first gap t1 is narrowed by closing the movable mold 20 by a predetermined amount. The supercritical fluid, the subcritical fluid, or the high pressure gas is then charged into the narrowed second gap t2 (t1>t2) (charging step).

That is, this charging operation is realized by preventing the supercritical fluid, the subcritical fluid, or the high pressure gas from leaking when the projection (projecting streak) 65 and the recess (groove) 15 formed on the periphery of the surface-reformed portion 61 of the molded product 60 and the stationary mold 10 corresponding to the periphery approach the second gap t2.

Specifically, when high density metal complex was introduced into the first gap t1, the mold clamping force of the movable mold 20 was increased, and the movable mold 20 was slowly closed to the second gap t2. With this configuration, the projection (projecting streak) 65 of the molded product 60 and the recess (groove) 15 of the stationary mold 10 function as a barrier which prevents the supercritical carbon dioxide staying in the radially inside space from leaking.

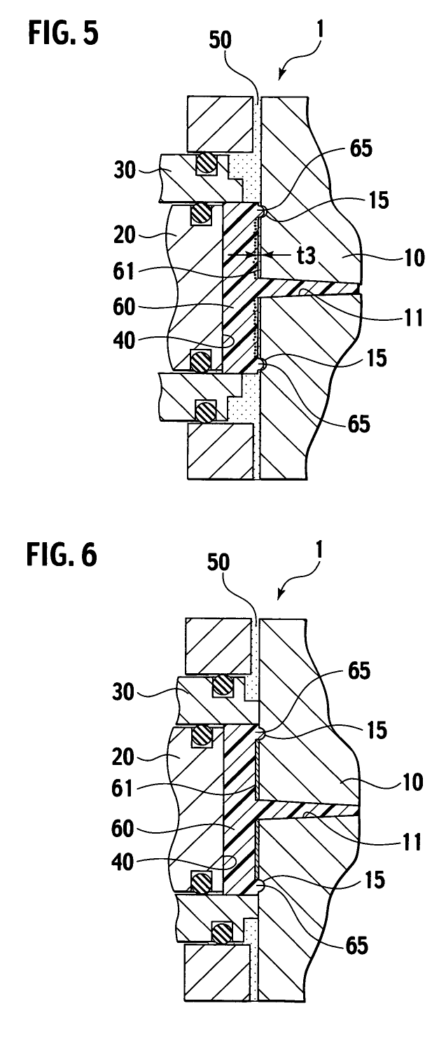

Next, as shown in FIG. 5, in order to promote the infiltration of the charged surface reforming material included in the charged supercritical fluid, subcritical fluid, or high pressure gas into the surface-reformed portion 61 of the molded product 60, the movable mold 20 is further closed, the second gap t2 is narrowed to a third gap t3 (t2>t3), and this state is maintained (maintaining step).

At this time, the supercritical fluid, the subcritical fluid, or the high pressure gas having the charged surface reforming material infiltrates into the surface-reformed portion 61 of the molded product 60. With this configuration, the state of the movable mold 20 is maintained until the gradual closing motion of the movable mold 20 is stopped.

More specifically, the clamping force of the movable mold 20 is further increased for compressing the material, the second gap t2 is narrowed to the third gap t3, thereby increasing the temperature of the metal complex and the pressure of the carbon dioxide in the supercritical state, thereby promoting the infiltration of the metal complex into the polycarbonate.

If the movable mold 20 was maintained in the state of the third gap t3, the supercritical carbon dioxide which stayed in the space located radially inward of the projection (projecting streak) 65 of the molded product 60 and in which the metal complex was melted was melted in polycarbonate, the movable mold 20 moved forward correspondingly, and the third gap t3 was gradually narrowed.

That is, in a state where the clamping force of the movable mold 20 is maintained, the third gap t3 is gradually narrowed, and when the forward movement of the movable mold 20 is stopped, the melting of the supercritical carbon dioxide is completed.

Next, as shown in FIG. 6, the molded product 60 is clamped and compressed (compressing step). At this time, the cavity ring 30 is moved forward to surround the periphery of the molded product 60, the movable mold 20 is moved forward and the molded product 60 is compressed.

More specifically, the melting of the supercritical carbon dioxide was completed and the forward movement of the movable mold 20 was stopped, the cavity ring 30 was moved forward. The clamping force of the movable mold 20 was further increased, and the molded product 60 was compressed and its state was maintained.

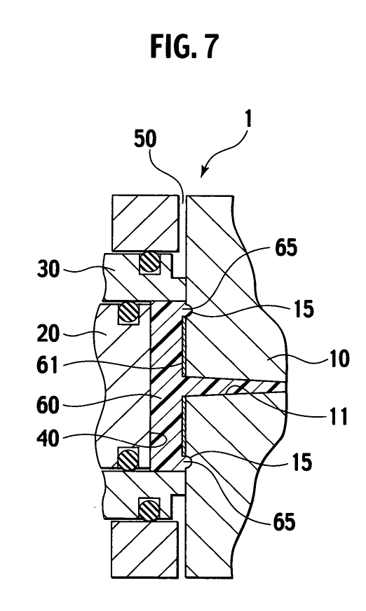

Next, as shown in FIG. 7, the supercritical carbon dioxide staying around the cavity 40 was discharged out from the introducing/discharging unit 50 (gas discharging step).

The mold was then opened, the taken out molded product 60 was coated with Ni plating in an electroless manner. As a result, the surface-reformed portion 61 surrounded by the projection (projecting streak) 65 was coated with high plating which had excellent surface and which was highly strong against peeling.

In the Example described above, a holding step shown in FIG. 5 was interposed between the charging step shown in FIG. 4 and the compressing step shown in FIG. 6. However, for example, when the surface reforming material included in the charged supercritical fluid, the subcritical fluid, or the high pressure gas is a material which can be easily infiltrated into the surface-reformed portion 61 of the molded product 60 the holding step shown in FIG. 5 can be omitted, and the compressing step shown in FIG. 6 can be performed after the charging step shown in FIG. 4.

### Comparative Example

Injection molding was performed in the same molding method as that of the Example except that the molded product and the mold surface were not provided with recess and projection. The injection molded product in the Comparative example is not uniformly coated with plating in the electroless manner, and some portions were not coated at all. It is conceived that this is because a portion of the supercritical fluid staying in the mold and the molded product surface and a portion of the metal complex which is the reforming material are discharged outside of the molded product in the closing process of the gap t.

In the Embodiment described above, the cavity 40 of a mold which becomes the space into which resin is charged can be opened and closed by the three members, i.e., the stationary mold 10, the movable mold 20 and the cavity ring (mold part) 30, however, the present invention is not limited to this.

That is, if the movable mold 20 is integrally provided with the cavity ring (mold part) 30, the cavity 40 which defines the product shape can be opened and closed by the two members, i.e., the stationary mold 10 and the movable mold 20.

Also in this case, the thermoplastic resin surface can be reformed substantially in the same manner as that of the surface reforming method of thermoplastic resin in the Embodiment described above.

According to the surface reforming apparatus 1 of the thermoplastic resin and the surface reforming method of the thermoplastic resin using the apparatus according to the invention, the surface reforming material melted in the supercritical fluid, the subcritical fluid, or the high pressure gas is charged into the gap between the stationary mold 10 and the surface-reformed portion 61 of the molded product 60, it can uniformly infiltrate into the surface-reformed portion 61 in a short time.

Even if a material has poor compatibility with respect to the thermoplastic resin such as metal complex, the material stays and infiltrates into the surface-reformed portion 61 by sealing the material in the gap between the stationary mold 10 and the surface-reformed portion 61. With this configuration, a material such as metal complex can uniformly infiltrate into the thermoplastic resin surface in a short time.

With this configuration, a sturdy surface can be reformed in a short time, roughness of the surface such as foaming can be suppressed, and a molding cycle can be shortened.

It is only necessary that a high density surface reforming material stays at the charging step, and the amount of the surface reforming material to be used can be reduced.

The reforming time depends on the capacity constituted by the gap between the stationary mold 10 and the surface-reformed portion 61 surrounded by the projection (projecting streak) 65 of the molded product 60 and an interior pressure in the gap. Since the capacity of the gap is very small, the time required for reforming can be shortened.

It is possible to adjust the width and height of the projection (projecting streak) 65 surrounding the surface-reformed portion 61 of the molded product 60 and the recess (groove) 15 of the stationary mold 10 corresponding to the projection (projecting streak) 65, and the gap and the reforming time at the charging step and maintaining step can be adjusted. With this configuration, even if compatibilities are different in a combination of various kinds such as various thermoplastic resins and various surface reforming materials, the surface reforming material can uniformly infiltrate into the thermoplastic resin surface.

The projection 65 and the recess (groove) 15 can have such shapes that the molded product is smoothly fit when compressed again. A semi-circular shape and a tapered shape having a fillet are suitable.

Furthermore, it is preferable that the surface reforming processing is performed in the supercritical state. However, if the pressure and temperature are increased by the mold closing motion at the maintaining step and as long as they are brought into the supercritical state, it is possible to perform the surface reforming processing at the introducing step and the charging step in the subcritical state or the high pressure gas state.

Especially in the case of the carbon dioxide, the temperature and pressure under the supercritical condition are 31° C. or higher and 7.4 MPa or higher, respectively. However, since sealing becomes difficult in this case, it is preferable that the temperature and pressure are 200°C. or lower and 30 MPa or lower, respectively.

Furthermore, shapes of a high pressure container or a mold for reforming the thermoplastic resin are not limited. A high pressure container in batch processing or a mold in an injection molding can be employed.

Further, any decompression method can be employed after the surface reforming processing. Since the capacity constituted by the gap between the stationary mold 10 and the surface-reformed portion 61 surrounded by the projection (projecting streak) 65 of the molded product 60 is very small, amount melting of supercritical fluid can be suppressed. Therefore, it is possible to obtain a molded product having excellent surface without using the heat cycle molding method or a gradual decompressing method, and continuous processing and industrialization become easy.

Further, if fluids which straightly flow bump against each other at an arbitrary angle or a barrier is provided at an introducing opening, it is possible to uniformly disperse the reforming material into the cavity 40.

By utilizing these characteristics, a high density reforming material can be distributed on a portion where reforming is desired.

A nozzle introducing hole like an ink jet, an injector, a porous material or the like can be also used.

According to the surface reforming method and surface reforming apparatus of thermoplastic resin of the present invention, by using a small amount of a surface reforming material, the surface reforming material can uniformly infiltrate into the thermoplastic resin surface in a short time.

What is claimed is:

1. A surface reforming method of a thermoplastic resin comprising:
a gap forming step of opening a movable mold after a thermoplastic resin is molded in a mold cavity to form a gap between a portion of a molded product and a stationary mold;
an introducing step of introducing supercritical fluid, subcritical fluid, or high pressure gas including a surface reforming material into the gap;
a charging step of narrowing the gap by closing the movable mold by a predetermined amount to prevent leaking of the introduced supercritical fluid, subcritical fluid, or high pressure gas from the gap, and of charging the supercritical fluid, the subcritical fluid, or the high pressure gas into a narrowed second gap; and
a compressing step of clamping and compressing the molded product.

2. The surface reforming method of a thermoplastic resin according to claim 1, wherein at the introducing step, the gap formed by the gap forming step is widened by a pressure of the introduced supercritical fluid, subcritical fluid, or high pressure gas, and the movable mold is maintained in a state where the widened first gap is maintained.

3. The surface reforming method of a thermoplastic resin according to claim 1, wherein the charging step is realized in such a manner that when a projection and a recess which are respectively formed on a periphery of the portion of a molded product and on a portion of the stationary mold corresponding to the periphery and which are opposed to each other approach the second gap, the supercritical fluid, the subcritical fluid, or the high pressure gas is prevented from leaking.

4. The surface reforming method of a thermoplastic resin according to claim 1, wherein at the compressing step, the movable mold which forms a cavity for defining a product shape between the movable mold and the stationary mold is moved forward, thereby compressing the molded product.

5. The surface reforming method of a thermoplastic resin according to claim 1, wherein at the compressing step, a mold part surrounding the mold cavity surrounds the molded product, moves the movable mold forward, and compresses the molded product.

6. The surface reforming method of a thermoplastic resin according to claim 1, wherein at least the charging step and the compressing step are performed by controlling a mold clamping force of the movable mold.

7. The surface reforming method of a thermoplastic resin according to claim 1, wherein the gap forming step is performed by controlling a position of the movable mold.

8. The surface reforming method of a thermoplastic resin according to claim 2, wherein at the introducing step, the gap formed at the gap forming step is widened to the first gap by a pressure of the supercritical fluid, the subcritical fluid, or the high pressure gas and then, position control of the movable mold is switched to mold clamping force control.

9. A molded product obtained by a following surface reforming method of a thermoplastic resin, in which a surface reforming material which is infiltrated into a portion of the molded product is metal fine grain, the method comprising:
a gap forming step of opening a movable mold after a thermoplastic resin is molded in a mold cavity to form a gap between a portion of the molded product and a stationary mold;
an introducing step of introducing supercritical fluid, subcritical fluid, or high pressure gas including the surface reforming material into the gap;
a charging step of narrowing the gap by closing the movable mold by a predetermined amount to prevent leaking of the introduced supercritical fluid, subcritical fluid, or high pressure gas from the gap, and of charging the supercritical fluid, the subcritical fluid, or the high pressure gas into a narrowed second gap; and
a compressing step of clamping and compressing the molded product.

10. The molded product according to claim 9, wherein the portion of the molded product into which the surface reforming material infiltrated is formed with a metal film by plating.

11. An injection molded product obtained by a following surface reforming method of a thermoplastic resin, in which a periphery of a portion of the injection molded product into which a surface reforming material infiltrates is surrounded by a projection or a recess, the method comprising:
a gap forming step of opening a movable mold after a thermoplastic resin is molded in a mold cavity to form a gap between a portion of the molded product and a stationary mold;
an introducing step of introducing supercritical fluid, subcritical fluid, or high pressure gas including a surface reforming material into the gap;
a charging step of narrowing the gap by closing the movable mold by a predetermined amount to prevent leaking of the introduced supercritical fluid, subcritical fluid, or high pressure gas from the gap, and of charging the supercritical fluid, the subcritical fluid, or the high pressure gas into a narrowed second gap; and
a compressing step of clamping and compressing the molded product.

12. The injection molded product according to claim 11, wherein the surface reforming material is metal fine grain.

13. The injection molded product according to claim 11, wherein height or depth of the projection or the recess is 0.01 mm or more and 0.5 mm or less.

14. A surface reforming method of a thermoplastic resin comprising:
a gap forming step of opening a movable mold after a thermoplastic resin is molded in a mold cavity to form a gap between a portion of a molded product and a stationary mold;
an introducing step of introducing supercritical fluid, subcritical fluid, or high pressure gas including a surface reforming material into the gap;
a charging step of narrowing the gap by closing the movable mold by a predetermined amount to prevent leaking of the introduced supercritical fluid, subcritical fluid, or high pressure gas from the gap, and of charging the supercritical fluid, the subcritical fluid, or the high pressure gas into a narrowed second gap;
a maintaining step of further closing the movable mold to maintain a state where the second gap is narrowed to a third gap for promoting infiltration of the surface reforming material included in the charged supercritical fluid, the subcritical fluid, or the high pressure gas into the portion; and
a compressing step of clamping and compressing the molded product.

15. The surface reforming method of a thermoplastic resin according to claim 14, wherein at the introducing step, the gap formed by the gap forming step is widened by a pressure of the introduced supercritical fluid, subcritical fluid, or high pressure gas, and the movable mold is maintained in a state where the widened first gap is maintained.

16. The surface reforming method of a thermoplastic resin according to claim 14, wherein the charging step is realized in such a manner that when a projection and a recess which are respectively formed on a periphery of the portion of a molded product and on a portion of the stationary mold corresponding to the periphery and which are opposed to each other approach the second gap, the supercritical fluid, the subcritical fluid, or the high pressure gas is prevented from leaking.

17. The surface reforming method of a thermoplastic resin according to claim 14, wherein at the maintaining step, the supercritical fluid, the subcritical fluid, or the high pressure gas including the charged surface reforming material infiltrates into the portion of the molded product, the movable mold is gradually closed, and the maintaining step is continued until the gradual closing motion stops.

18. The surface reforming method of a thermoplastic resin according to claim 14, wherein at the compressing step, the movable mold which forms a cavity for defining a product shape between the movable mold and the stationary mold is moved forward, thereby compressing the molded product.

19. The surface reforming method of a thermoplastic resin according to claim 14, wherein at the compressing step, a mold part surrounding the mold cavity surrounds the molded product, moves the movable mold forward, and compresses the molded product.

20. The surface reforming method of a thermoplastic resin according to claim 14, wherein at least the charging step, the maintaining step, and the compressing step are performed by controlling a mold clamping force of the movable mold.

21. The surface reforming method of a thermoplastic resin according to claim 14, wherein the gap forming step is performed by controlling a position of the movable mold.

22. The surface reforming method of a thermoplastic resin according to claim 15, wherein at the introducing step, the gap formed at the gap forming step is widened to the first gap by a pressure of the supercritical fluid, the subcritical fluid, or the high pressure gas and then, position control of the movable mold is switched to mold clamping force control.

23. A molded product obtained by a following surface reforming method of a thermoplastic resin, in which a surface reforming material which is infiltrated into a portion of the molded product is metal fine grain, the method comprising:
a gap forming step of opening a movable mold after a thermoplastic resin is molded in a mold cavity to form a gap between a portion of the molded product and a stationary mold;
an introducing step of introducing supercritical fluid, subcritical fluid, or high pressure gas including the surface reforming material into the gap;
a charging step of narrowing the gap by closing the movable mold by a predetermined amount to prevent leaking of the introduced supercritical fluid, subcritical fluid, or high pressure gas from the gap, and of charging the supercritical fluid, the subcritical fluid, or the high pressure gas into a narrowed second gap;
a maintaining step of further closing the movable mold to maintain a state where the second gap is narrowed to a third gap for promoting infiltration of the surface reforming material included in the charged supercritical fluid, the subcritical fluid, or the high pressure gas into the portion; and
a compressing step of clamping and compressing the molded product.

24. The molded product according to claim 23, wherein the portion of the molded product into which the surface reforming material infiltrated is formed with a metal film by plating.

25. An injection molded product obtained by a following surface reforming method of a thermoplastic resin, in which a periphery of a portion of the injection molded product into which a surface reforming material infiltrates is surrounded by a projection or a recess, the method comprising:
a gap forming step of opening a movable mold after a thermoplastic resin is molded in a mold cavity to form a gap between a portion of the molded product and a stationary mold;
an introducing step of introducing supercritical fluid, subcritical fluid, or high pressure gas including a surface reforming material into the gap;
a charging step of narrowing the gap by closing the movable mold by a predetermined amount to prevent leaking of the introduced supercritical fluid, subcritical fluid, or high pressure gas from the gap, and of charging the supercritical fluid, the subcritical fluid, or the high pressure gas into a narrowed second gap;
a maintaining step of further closing the movable mold to maintain a state where the second gap is narrowed to a third gap for promoting infiltration of the surface reforming material included in the charged supercritical fluid, the subcritical fluid, or the high pressure gas into the portion; and
a compressing step of clamping and compressing the molded product.

26. The injection molded product according to claim 25, wherein the surface reforming material is metal fine grain.

27. The injection molded product according to claim 25, wherein height or depth of the projection or the recess is 0.01 mm or more and 0.5 mm or less.

28. A surface reforming apparatus of a thermoplastic resin, comprising:
a stationary mold;
a movable mold; and
an introducing/discharging unit of supercritical fluid, subcritical fluid, or high pressure gas including a surface reforming material; wherein
a projection or a recess are formed on a periphery of a portion of a molded product which is separated from the stationary mold when the movable mold is opened after the thermoplastic resin is molded in a mold cavity and a portion of the stationary mold corresponding to the periphery, and the projection and the recess are formed to be opposed to each other.

29. The surface reforming apparatus of the thermoplastic resin according to claim 28, wherein the projection or the recess functions to prevent leaking of the supercritical fluid, the subcritical fluid, or the high pressure gas, which is introduced from the introducing/discharging unit by opening the movable mold after the molding, and then charged between the stationary mold and the portion of the molded product by closing the movable mold by a predetermined amount.
